(19) United States
(12) Patent Application Publication
(10) Pub. No.: US 2004/0012808 A1
(43) Pub. Date: Jan. 22, 2004

(54) Network-based technical support and diagnostics

(76) Inventors: David M. Payne, Meridian, ID (US); Tim M. Hoberock, Boise, ID (US); Steve M. Frane, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,082

(22) Filed: Jun. 4, 2001

(51) Int. Cl. G06F 15/00; G06F 9/44

(52) U.S. Cl. 358/1.15; 717/124; 717/167

(57) ABSTRACT

A diagnostic service system includes a networked electronic device that can self-determine a need for technical support, initiate communication with a technical support system, and provide information corresponding to the need for technical support to the technical support system. The technical support system receives the information and compares the information with an information database to determine a solution, or solutions, for the electronic device in accordance with the received information. The electronic device receives the solution, or solutions, from the technical support system and implements the solutions to resolve the need for technical support in the electronic device, or renders instructions for user interaction with the electronic device to implement the solution.

### TECHNICAL FIELD

This invention relates to a technical support and diagnostics system and, in particular, to determining a solution for a networked computing device having a need for technical support.

### BACKGROUND

When a customer of a computing device, such as a printer for example, encounters an operational or functional problem with the device, the customer can reference a user's manual, access technical support instructions that are rendered on a display integrated with the device, or contact a customer support and service center. A manufacturer of a computing device typically provides the customer service and diagnostics support to assist customers when such a problem occurs.

Typically, a user's manual for a computing device only has descriptions and solutions to problems that were known or could be foreseen prior to the device having been manufactured. That is, a user manual for such a device may not provide a solution for a particular problem because it is not up-to-date. Similarly, any technical support instructions that might be accessible within the device are provided when the device is manufactured and may not be up-to-date to provide a solution for a particular problem.

Contacting a customer service and support center can result in an expense to the customer, as well as to the manufacturer that provides the technical support. A customer can incur expenses that include the service call itself, as well as an hourly rate to speak with a technician or having a technician dispatched to evaluate the problem with the computing system device. In addition, the manufacturer incurs the expenses related to having customer service and technical support personnel available in the eventuality that a customer will call with a problem.

Many of the expenses that are incurred either by the customers or by the manufacturer of a computing device are a product of the human interaction needed to determine a solution to an operational or functional problem with the device. Theses expenses can be reduced, or even eliminated, by providing a system in which updated technical support information is made available, or a problem with a device is resolved, without the need for service and technical support personnel interaction.

Accordingly, there is a continuing need to provide better and cost effective customer service support and diagnostics to assist customers effectively and efficiently with computing device operational and functional problems.

### SUMMARY

A diagnostic service system includes a networked electronic device, such as a printer for example, that can self-determine a need for technical support and automatically initiate communication with a technical support system. After initiating communication, the electronic device provides information corresponding to the need for technical support to the technical support system. The electronic device can provide the information to the technical support system as part of an email message, or via other forms of network communications.

The technical support system receives the information corresponding to the need for technical support and compares the information with an information database to determine a solution, or solutions, for the electronic device in accordance with the received information. The information database maintains descriptions of device needs for technical support, and solutions corresponding to a particular description of a device need for technical support.

The technical support system determines a solution, or solutions, to the need for technical support and sends the solution information to the requesting electronic device. The electronic device receives the solution information from the technical support system and automatically implements the solution information to resolve the need for technical support in the electronic device. The electronic device can receive the solution information as part of an email message, or via other forms of network communications.

Alternatively to the electronic device automatically implementing the solution information, the electronic device can render solution instructions for user interaction with the electronic device to implement the solution information. The electronic device can render the solution instructions on a display device integrated or connected to the electronic device, or the electronic device can print the solution instructions, such as with the printer for example.

### BRIEF DESCRIPTION OF THE DRAWINGS

The same numbers are used throughout the drawings to reference like features and components.

FIG. 1 is block diagram that illustrates various components of an exemplary printing device.

FIG. 2 is block diagram that illustrates various components of an exemplary computing device.

FIG. 3 is a block diagram that illustrates components of a technical support and diagnostics system in an exemplary network environment.

FIG. 4 is a block diagram that illustrates components of an alternative technical support and diagnostics system in an exemplary network environment.

FIG. 5 is a flow diagram that describes a method for a technical support and diagnostics system.

### DETAILED DESCRIPTION

Introduction

Systems and methods for a technical support and diagnostics system are described. A network-based support system provides electronic and computing device users help with operational and functional problems that occur with such devices, and reduces call volume for customer service personnel at a customer support center.

A network-based support system having a centralized database that maintains descriptions of known problems also facilitates technical support providers. Solutions for a known problem can be associated with a problem in the database such that when a device initiates a service call to the support system, a solution to the problem is available to be determined without the need for either user or service personnel interaction. This also eliminates the need to have a service person assist more than one user with the same device problem.

Exemplary Printer Architecture

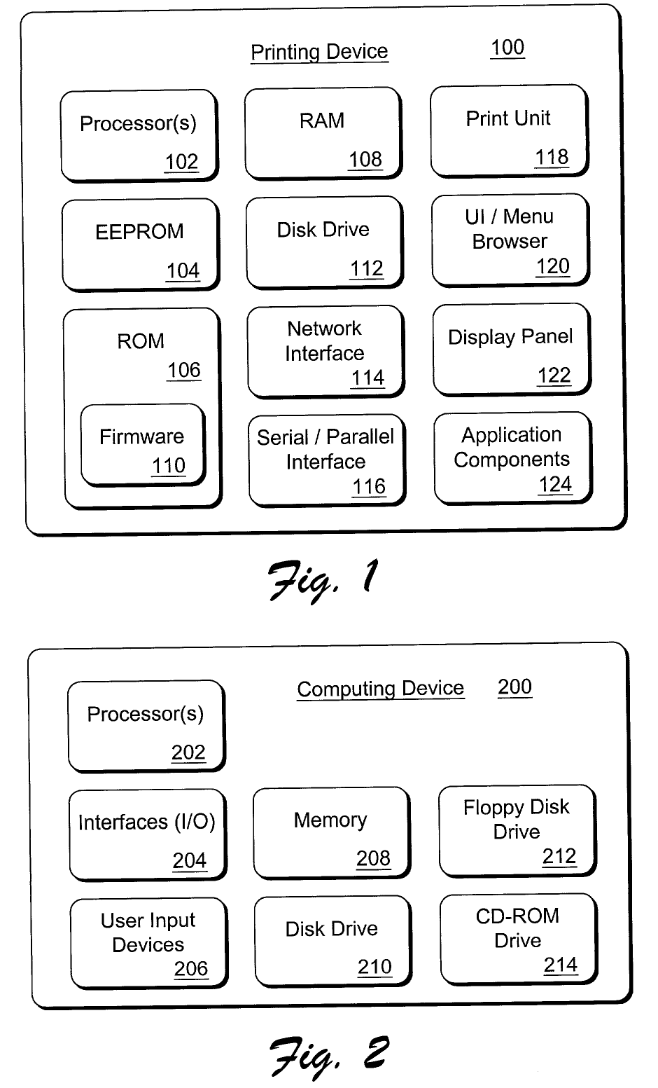

FIG. 1 illustrates various components of an exemplary printing device 100 that can be utilized to implement the inventive techniques described herein. Printer 100 includes one or more processors 102, an electrically erasable programmable read-only memory (EEPROM) 104, ROM 106 (non-erasable), and a random access memory (RAM) 108. Although printer 100 is illustrated having an EEPROM 104 and ROM 106, a particular printer may only include one of the memory components. Additionally, although not shown, a system bus typically connects the various components within the printing device 100.

The printer 100 also has a firmware component 110 that is implemented as a permanent memory module stored on ROM 106. The firmware 110 is programmed and tested like software, and is distributed with the printer 100. The firmware 110 can be implemented to coordinate operations of the hardware within printer 100 and contains programming constructs used to perform such operations.

Processor(s) 102 process various instructions to control the operation of the printer 100 and to communicate with other electronic and computing devices. The memory components, EEPROM 104, ROM 106, and RAM 108, store various information and/or data such as configuration information, fonts, templates, data being printed, and menu structure information. Although not shown, a particular printer can also include a flash memory device in place of or in addition to EEPROM 104 and ROM 106.

Printer 100 also includes a disk drive 112, a network interface 114, and a serial/parallel interface 116. Disk drive 112 provides additional storage for data being printed or other information maintained by the printer 100. Although printer 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer.

Network interface 114 provides a connection between printer 100 and a data communication network. The network interface 114 allows devices coupled to a common data communication network to send print jobs, menu data, and other information to printer 100 via the network. Similarly, serial/parallel interface 116 provides a data communication path directly between printer 100 and another electronic or computing device. Although printer 100 is illustrated having a network interface 114 and serial/parallel interface 116, a particular printer may only include one interface component.

Printer 100 also includes a print unit 118 that includes mechanisms arranged to selectively apply ink (e.g., liquid ink, toner, etc.) to a print media such as paper, plastic, fabric, and the like in accordance with print data corresponding to a print job. For example, print unit 118 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 118 can also be configured to support duplex printing, for example, by selectively flipping or turning the print media as required to print on both sides. Those skilled in the art will recognize that there are many different types of print units available, and that for the purposes of the present invention, print unit 1 18 can include any of these different types.

Printer 100 also includes a user interface and menu browser 120, and a display panel 122. The user interface and menu browser 120 allows a user of the printer 100 to navigate the printer's menu structure. User interface 120 can be indicators or a series of buttons, switches, or other selectable controls that are manipulated by a user of the printer. Display panel 122 is a graphical display that provides information regarding the status of the printer 100 and the current options available to a user through the menu structure.

Printer 100 can, and typically does include application components 124 that provide a runtime environment in which software applications or applets can run or execute. One exemplary runtime environment is a Java Virtual Machine (JVM). Those skilled in the art will recognize that there are many different types of runtime environments available. A runtime environment facilitates the extensibility of printer 100 by allowing various interfaces to be defined that, in turn, allow the application components 124 to interact with the printer.

Exemplary Computer Architecture

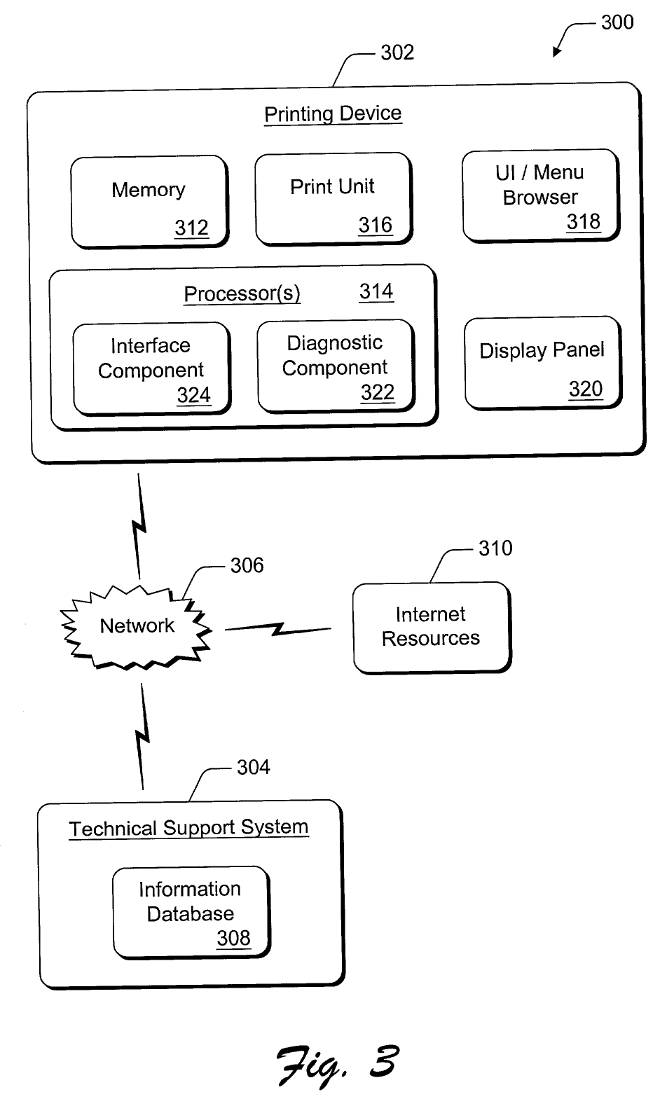

FIG. 2 illustrates various components of an exemplary computing device 200 that can be utilized to implement the inventive techniques described herein. Computer 200 includes one or more processors 202, interfaces 204 for inputting and outputting data, and user input devices 206. Processor(s) 202 process various instructions to control the operation of computer 200, while interfaces 204 provide a mechanism for computer 200 to communicate with other electronic and computing devices. User input devices 206 include a keyboard, mouse, pointing device, or other mechanisms for interacting with, and inputting information to computer 200.

Computer 200 also includes a memory 208 (such as ROM and/or RAM), a disk drive 210, a floppy disk drive 212, and a CD-ROM drive 214. Memory 208, disk drive 210, floppy disk drive 212, and CD-ROM drive 214 provide data storage mechanisms for computer 200. Although not shown, a system bus typically connects the various components within the computing device 200.

Exemplary Technical Support and Diagnostics System

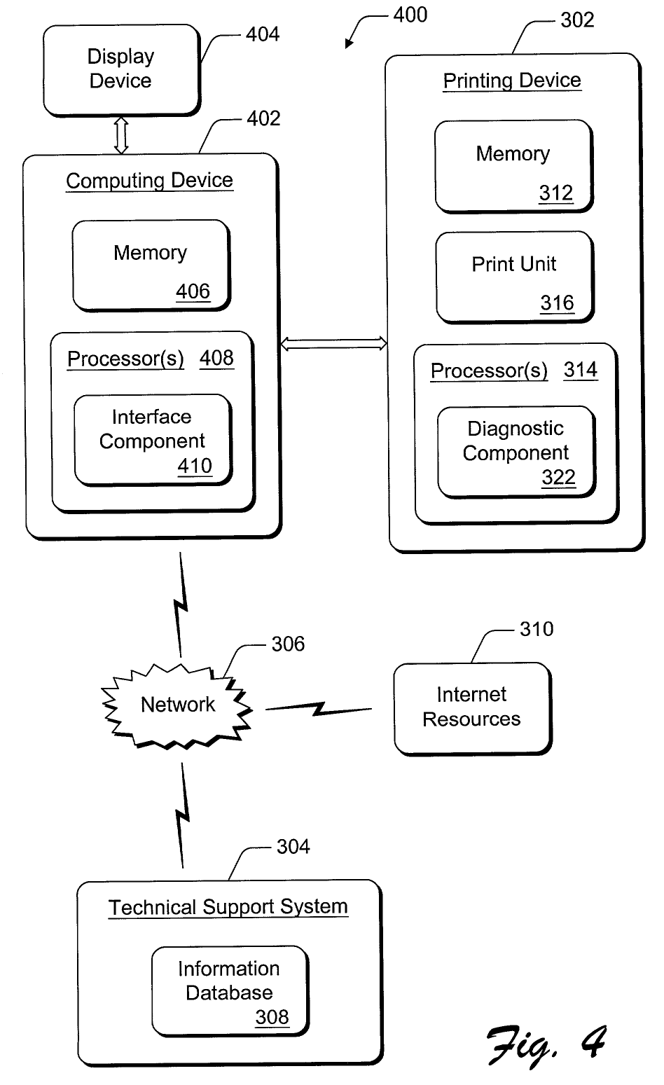

FIG. 3 illustrates components of a network environment 300 in which a printing device 302 is connected with a technical support system 304 via a network system 306. The printing device 302 can include one or more of the components of the exemplary printing device 100 (FIG. 1). The printing device 302 can be implemented as a stand alone device, such as multi-function device that prints, faxes, scans, and/or copies. Additionally, printing device 302 is configured to communicate directly with the technical support system 304, and without an inter-connected personal computer.

The technical support system 304 has an information database 308 that maintains technical support and diagnostic information and data. Those skilled in the art will recognize that information database 308 can include, or be implemented with, one or more of the components of the exemplary computing device 200 (FIG. 2), or with any other computing device, appliance server, and the like. Furthermore, an information database can be implemented with more than one computing device in a distributed network environment.

The network system 306 can be any type of network, such as a local area network (LAN) or a wide area network (WAN), using any type of network topology and any network communication protocol. Although only a few devices are shown interconnected via network system 306, a typical network system can have any number of devices connected to it, either directly or indirectly, via another network system. The Internet, having any number of Internet resources 310, is an example of multiple connected network systems each having multiple devices. The printing device 302 and the technical support system 304 can also have modems and/or network cards that facilitate network communication and data transfer via network system 306.

The printing device 302 includes a memory component 312 which can be implemented with an EEPROM 104, ROM 106 with firmware 110, RAM 108, and/or disk drive 112. Each of these memory components are described above with respect to the exemplary printing device 100 (FIG. 1). The printing device 302 also includes one or more processors 314, a print unit 316, a user interface and menu browser 318, and a display panel 320. Each of these components are also described above with respect to the exemplary printing device 100 (FIG. 1). It is to be appreciated, however, that printing device 302 can be implemented with only some of the illustrated components. For example, printing device 302 can be implemented in the network environment 300 without a user interface and menu browser 318, and without a display panel 320.

The printer memory 312, which can contain firmware as described above, maintains a diagnostic component 322 that executes on processor 314. The diagnostic component 322 monitors the operations and functions of the printer 302 to determine if the printer is operating and functioning properly. If a problem occurs repeatedly within the printer 302, such as repeated paper jams that would indicate misaligned or worn rollers, or if a series of different problems occur, the printer 302 can initiate communications with the technical support system 304 via the network system 306 and provide information about the printer problem, or problems, as monitored by the diagnostic component 322.

The printer 302 can communicate with the technical support system 304 via login access over the Internet, via a modem, or via an email system. The manufacturer of the printer 302, or of any other electronic or computing device, can include email information and logon passwords within the device firmware, for example, when the device is manufactured to facilitate the device being able to contact and establish communications with the manufacturer's particular technical support system. Those skilled in the art will recognize that these examples of network communication are only a few of the many possible ways to access an information database in a computing system architecture via a network system.

When the diagnostic component 322 determines that an operational or functional problem with printer 302 has occurred, an interface component 324 that executes on processor 314 sends information and data pertaining to the printer problem directly to the technical support system 304 for evaluation of the problem. Such information and data can include product specific information, printer configuration information, general information and error logs, firmware and software information, and the like.

An alternative to the printer 302 initiating contact with the technical support system 304 is that the printer can notify a user of the printer that a problem or a need for technical support has occurred so that the user can initiate the service contact. The printer 302 can notify the user via the user interface and menu browser 318 on the display panel 320. An advantage to having the printer 302, or other electronic or computing device, contact and communicate with the technical support system 304 directly is that there is less chance of an error when translating the information and data pertaining to any recognized or determined problem.

The technical support system 304 compares any received information and data pertaining to a computing system peripheral device problem with the information database 308 to determine if there is one or more solutions available for the problem. The technical support and diagnostic information maintained by information database 308 includes possible problem descriptions and corresponding solutions to the problems.

If a solution is available for a particular problem, the technical support system 304 returns the information pertaining to the solution to the device having provided the problem information. Additionally, the technical support system 304 can evaluate the information and data submitted by the computing device, such as printer 302, to determine if system or device updates are available. If system and/or device updates are available, the technical support system 304 can send the information back to the particular device along with any available solutions for an operational or functional problem. The technical support system 304 can also send information to the device to direct the device to access Internet resources 310 to obtain any available system or device updates.

A solution for an electronic or computing device problem, or a device update, can involve updating firmware or software drivers within the device. A solution can also involve updating writeable memory in the computing device with help menus, warnings, and/or error messages, for example, to provide a user with the latest available support information about a particular device.

A solution for a problem received by the printer 302 can be implemented by the printer itself, or the solution can be rendered for user interaction with the printer to implement the solution. A solution can be rendered as a printed page of instructions with the print unit 316, or as instructions or messages displayed on the display panel 320.

In addition to determining if there is a solution available for a computing device operational or functional problem, the technical support system can maintain a call log of the problem data and generate a case number corresponding to the request for a problem solution. The case number is a reference identifier that can also be rendered for reference by a user of the device if a follow-up call to customer service personnel or service technicians is required, such as if the problem was not remedied by the solution(s) provided by the technical support system 304. With the case number reference and the corresponding call log of data pertaining to the computing device and problem, the service personnel will already have all of the pertinent information regarding the customer's problem stored in an accessible location, such as in the information database 308.

The printer 302 does not have to be connected to a personal computer to facilitate the described information transactions between the printer and the technical support system 304. The printer 302 has the capability to contact the technical support system 304 directly and coordinate the information exchange. Additionally, those skilled in the art will recognize that the printing device 302 in network environment 300 can be replaced with other electronic device that may not have a print unit 316. Other electronic devices can include a personal digital assistant (PDA), a cellular phone, or any other electronic, portable electronic, or wireless device.

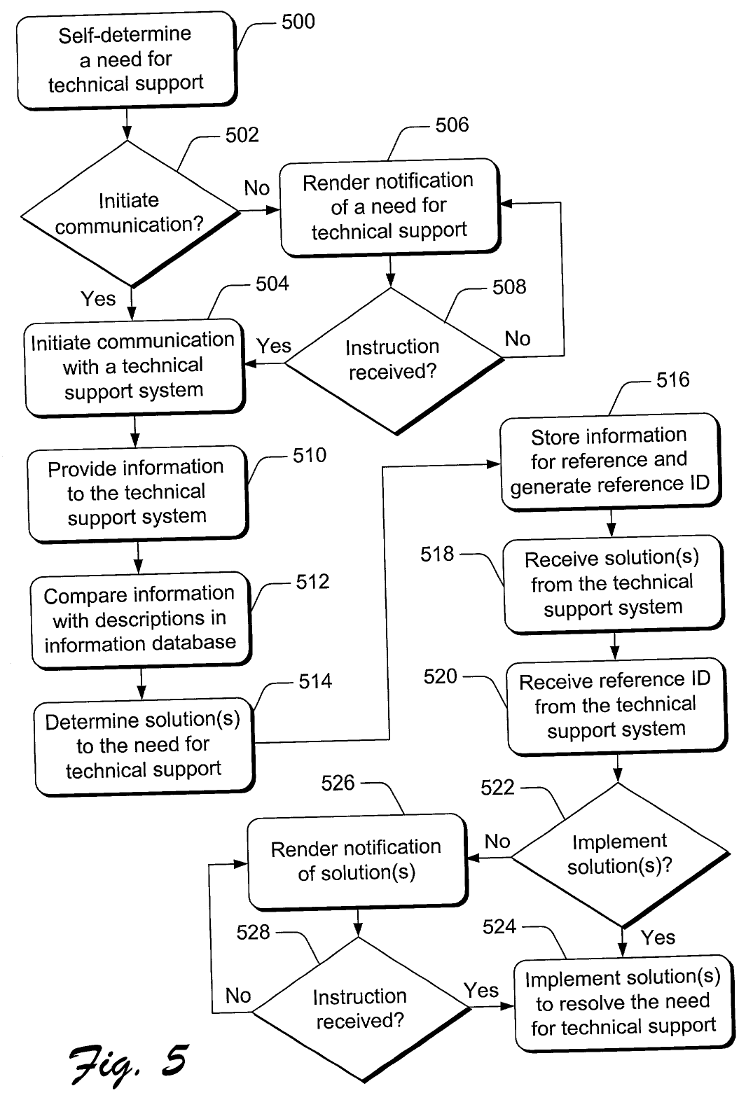

FIG. 4 illustrates components of a network environment 400 that is an alternative to the technical support and diagnostics system illustrated as network environment 300 (FIG. 3). Network environment 400 includes a computing device 402 that is connected with a technical support system 304 via a network system 306. The network environment 400 also includes printing device 302 connected to the computing device 402, and a display device 404 connected to the computing device 402.

The printing device 302 and the various printing device components, as well as the network system 306, technical support system 304, and Internet resources 310 are all described above with reference to network environment 300 (FIG. 3). Computing device 402 includes a memory component 406 and one or more processors 408. An interface component 410 executes on processor 408. Although shown having only a few components, computing device 402 can include, or be implemented with, one or more of the components of the exemplary computing device 200 (FIG. 2).

When the diagnostic component 322 in printing device 302 determines that an operational or functional problem with printer 302 has occurred, interface component 410 executing on processor 408 sends information and data pertaining to the printer problem to the technical support system 304 for evaluation of the problem. Such information and data can include printer specific information such as printer configuration information, general information and error logs, firmware and software information, and the like. The information and data can also include computing device specific information such as system settings, software driver information, operating system information, and the like.

Alternatively, the computing device 402 can notify a user of the printer 302 that a problem or a need for technical support has occurred so that the user can initiate the service contact. The computing device 402 can notify the user via the display device 404 connected to the computing device.

As described above with reference to network environment 300 (FIG. 3), technical support system 304 compares any received information and data pertaining to an electronic or computing device problem with the information database 308 to determine if there is one or more solutions available for the problem. If a solution is available, the technical support system 304 returns information pertaining to the solution to the computing device 402.

The computing device 402 can then implement the solution for the problem with the printer 302, route the information and data to the printer so that the solution can be implemented by the printer itself, or the solution can be rendered for user interaction with the computing device and printer to implement the solution. A solution can be rendered as a printed page of instructions with print unit 316, or as instructions or messages displayed on the display device 404. Instructions and/or messages displayed on display device 404 can also be presented to a user in the form of a printing device virtual control panel that is displayed as a user interface on the display device for user interaction with the printing device 302 via the computing device 402.

Additionally, technical support system 304 can evaluate the information and data submitted by computing device 402 for printer 302 to determine if system or device updates are available. If system or device updates are available, technical support system 304 can send the information back to the computing device 402 along with any available solutions for an operational or functional problem with the printer 302. The technical support system 304 can also send information to the computing device 402 to direct the device to access Internet resources 310 to obtain any available system or device updates for printer 302.

Methods for a Technical Support and Diagnostics System

FIG. 5 illustrates a method for a technical support and diagnostics system. The order in which the method is described is not intended to be construed as a limitation. Furthermore, the method can be implemented in any suitable hardware, software, firmware, or combination thereof.

At block 500, an electronic or computing device, such as printing device 302 for example, self-determines a need for technical support. A need for technical support can include an operational and/or functional problem with the device, or can include a need to update firmware components, software components, and the like.

At block 502, the electronic device determines whether it can initiate communication with a technical support system without user interaction. That is, the electronic device determines if it has been authorized to perform initiating communication without further user interaction of the device. If the device can initiate the communication (i.e., “yes” from block 502), the electronic device initiates communication with the technical support system at block 504. For example, printing device 302 initiates communication with technical support system 304 via the network system 306.

If the device cannot initiate communication automatically (i.e., “no” from block 502), the electronic device renders a notification of the self-determined need for technical support at block 506. For example, printing device 302 displays the notification for a user of the device on display panel 320, or prints the notification with print unit 316.

At block 508, the electronic device awaits an instruction to initiate communication with the technical support system. If the device does not receive the instruction, such as from a user of the device for example, (i.e., “no” from block 508), the device maintains the notification for the user.

If the electronic device receives an instruction to initiate communication with the technical support system (i.e., “yes” from block 508), the device initiates communication with the technical support system at block 504. At block 510, the electronic device provides information corresponding to the self-determined need for technical support to the technical support system. For example, printing device 302 can communicate the information to technical support system 304 as part of an email message via network system 306.

At block 512, the technical support system compares the received information with a database of descriptions of device needs for technical support. For example, technical support system 304 compares the information corresponding to the printer's 302 self-determined need for technical support with information maintained in information database 308. Each description of a device need for technical support maintained in the information database has one or more corresponding solutions.

At block 514, the technical support system determines one or more solutions corresponding to the received information about the need for technical support. For example, the technical support system 304 can receive information indicating that printer 302 will not print. The technical support system 304 compares the information with similar problem descriptions maintained in the information database 308 and determines that the printer 302 may be out of paper, out of toner, have on inoperable temperature sensor, have worn rollers, or any other operational or functional problem.

At block 516, the technical support system stores the received information about the particular need for technical support in a history log and generates a reference identifier that corresponds to the problem and solution transaction between the technical support system and the electronic device. A user of the electronic device can use the reference identifier for a follow-up call to customer service personnel or service technicians.

At block 518, the electronic device receives the one or more solutions determined by the technical support system. For example, printing device 302 can receive the one or more solutions from technical support system 304 as part of an email message via network system 306. Additionally, at block 520, the electronic device receives the reference identifier corresponding to the service communication generated by the technical support system.

At block 522, the electronic device determines whether it can implement the received solution(s) to resolve the self-determined need for technical support without user interaction. That is, the electronic device determines if it has been authorized to perform implementing a solution without further user interaction of the device. If the device can implement a solution (i.e., “yes” from block 522), the electronic device implements the solution(s) received from the technical support system to resolve the need for technical support at block 524.

If the device cannot implement a solution without user interaction (i.e., “no” from block 522), the electronic device renders a notification of the solution at block 526. For example, printing device 302 displays a notification of a solution on display panel 320, or prints the notification with print unit 316. At block 528, the electronic device awaits an instruction to implement the one or more solutions received from the technical support system.

If the device does not receive an instruction, such as from a user of the device for example, (i.e., “no” from block 528), the device maintains the notification for the user. If the electronic device receives a solution instruction (i.e., “yes” from block 528), the electronic device implements the solution instruction at block 524.

Conclusion

A technical support and diagnostics system facilitates both computing system device users and technical support and service providers. A networked computing or electronic device can self-determine a need for technical support, such as for an operational or functional problem, contact a technical support system, and implement a solution all without the need for user interaction with the device. Additionally, the networked computing or electronic device, such as a printer for example, does not have to be connected to a personal computer to accomplish such self-diagnostics and solution implementation.

The described system provides up-to-date solutions for device problems without the need for user interaction with the device, and without the need for customer service personnel or technicians to evaluate a problem. This is particularly useful for a common error or problem. A technician “repairs” the problem once and adds the repair information to a technical support database. Any subsequent requests for service for the common error or problem will be automatically sent a solution without the need for user and/or technical personnel interaction.

The described system also reduces the number of service calls and requests received at a service and support center to support personnel. The system bypasses the customer support personnel service technicians and allows a customer to help him or herself which results in time and cost savings for both a customer of a device and the manufacturer providing the customer service and support.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A diagnostic service system, comprising:
a printing device configured to self-determine a need for technical support;
a technical support system configured to receive information from the printing device, the information corresponding to the self-determined need for technical support;
the technical support system further configured to determine a solution for the printing device in accordance with the received information; and
the printing device further configured to receive the solution from the technical support system and implement the solution to resolve the need.

2. A diagnostic service system as recited in claim 1, further comprising a computing device connected to the printing device, wherein the computing device is configured to receive the information from the printing device, route the information to the technical support system, and receive the solution from the technical support system.

3. A diagnostic service system as recited in claim 1, wherein the technical support system is configured to receive the information from the printing device as part of an email message.

4. A diagnostic service system as recited in claim 1, wherein the printing device is configured to receive the solution as part of an email message.

5. A diagnostic service system as recited in claim 1, wherein the technical support system is further configured to compare the received information with descriptions of device needs for technical support to determine the solution, each description of a device need for technical support corresponding to one or more solutions.

6. A diagnostic service system as recited in claim 1, further comprising a database configured to maintain one or more descriptions of device needs for technical support, and one or more solutions corresponding to a particular description of a device need for technical support.

7. A diagnostic service system as recited in claim 1, wherein the technical support system is further configured to maintain the received information and generate a corresponding reference identifier, and wherein the printing device is further configured to receive the reference identifier.

8. A diagnostic service system as recited in claim 1, wherein the printing device is further configured to initiate communication with the technical support system and provide the information to the technical support system.

9. A diagnostic service system as recited in claim 1, wherein the printing device is further configured to provide the information to the technical support system without user interaction with the printing device.

10. A diagnostic service system as recited in claim 1, wherein the printing device is further configured to render a notification of the self-determined need for technical support, and wherein the printing device is further configured to provide the information to the technical support system after receiving an instruction to said provide information.

11. A diagnostic service system as recited in claim 1, wherein the printing device is further configured to render instructions for user interaction with the printing device to said implement the solution.

12. A diagnostic service system as recited in claim 1, wherein the printing device is further configured to render printed instructions for user interaction with the printing device to said implement the solution.

13. A diagnostic service system as recited in claim 1, wherein the printing device is further configured to download an Internet resource to said implement the solution.

14. An electronic device, comprising:
a diagnostic component configured to self-determine a need of the electronic device for technical support;
an interface component configured to provide information corresponding to the self-determined need for technical support to a technical support system, the technical support system determining a solution to the need in accordance with the information;
the interface component further configured to receive the solution from the technical support system; and
the diagnostic component further configured to implement the solution to resolve the need.

15. An electronic device as recited in claim 14, wherein the interface component is configured to provide the information as part of an email message.

16. An electronic device as recited in claim 14, wherein the interface component is configured to receive the solution as part of an email message.

17. An electronic device as recited in claim 14, wherein the interface component is further configured to automatically initiate communication with the technical support system to said provide the information.

18. An electronic device as recited in claim 14, further comprising a display device configured to render a notification of the self-determined need for technical support, and wherein the interface component is further configured to initiate communication with the technical support system after receiving an instruction to said provide the information.

19. An electronic device as recited in claim 14, further comprising a printing assembly configured to print a notification of the self-determined need for technical support, and wherein the interface component is further configured to initiate communication with the technical support system after receiving an instruction to said provide the information.

20. An electronic device as recited in claim 14, further comprising a display device configured to render instructions for user interaction with the electronic device to said implement the solution.

21. An electronic device as recited in claim 14, further comprising a printing assembly configured to print instructions for user interaction with the electronic device to said implement the solution.

22. A printing device, comprising:
a diagnostic component configured to self-determine a need of the printing device for technical support;
an interface component configured to initiate communication with a technical support system to provide information corresponding to the self-determined need for technical support, the technical support system determining a solution to the need in accordance with the information;
the interface component further configured to receive the solution from the technical support system; and
a diagnostic component configured to implement the solution to resolve the need.

23. A printing device as recited in claim 22, wherein the interface component said initiates communication and provides information without user interaction with the printing device.

24. A printing device as recited in claim 22, wherein the diagnostic component said implements the solution without user interaction with the printing device.

25. A printing device as recited in claim 22, further comprising a display device configured to render a notification of the self-determined need for technical support, and wherein the interface component said initiates communication after receiving an instruction to said provide the information.

26. A printing device as recited in claim 22, further comprising a printing assembly configured to print a notification of the self-determined need for technical support, and wherein the interface component said initiates communication after receiving an instruction to said provide the information.

27. A printing device as recited in claim 22, further comprising a display device configured to render instructions for user interaction with the printing device to said implement the solution.

28. A printing device as recited in claim 22, further comprising a printing assembly configured to print instructions for user interaction with the printing device to said implement the solution.

29. A method, comprising:
with an electronic device, self-determining a need for technical support;
providing information corresponding to the need for technical support to a technical support system;
receiving a solution to the need for technical support from the technical support system; and
implementing the solution to resolve the need.

30. A method as recited in claim 29, wherein said self-determining is performed by an electronic device comprising a printing device.

31. A method as recited in claim 29, wherein said self-determining is performed by an electronic device comprising a personal digital assistant.

32. A method as recited in claim 29, wherein said providing comprises providing the information to the technical support system as part of an email message.

33. A method as recited in claim 29, wherein said receiving comprises receiving the solution as part of an email message.

34. A method as recited in claim 29, further comprising initiating communication with the technical support system without user interaction with the electronic device, said initiating communication to provide the information.

35. A method as recited in claim 29, further comprising rendering a notification of the need for technical support and initiating communication with the technical support system after receiving an instruction to provide the information.

36. A method as recited in claim 29, further comprising printing a notification of the need for technical support and initiating communication with the technical support system after receiving an instruction to provide the information.

37. A method as recited in claim 29, further comprising determining the solution by comparing the information with descriptions of device needs for technical support, each description of a device need for technical support corresponding to one or more solutions.

38. A method as recited in claim 29, further comprising generating a reference identifier corresponding to the information, the technical support system maintaining the information and providing the reference identifier to the electronic device.

39. A method as recited in claim 29, wherein said implementing comprises rendering user instructions for user interaction with the electronic device to said resolve the need.

40. A method as recited in claim 29, wherein said implementing comprises printing user instructions for user interaction with the electronic device to said resolve the need.

41. A computer-readable medium comprising computer executable instructions that, when executed, direct an electronic device to perform a method, comprising:
self-determining a need for technical support;
initiating communication with a technical support system;
providing information corresponding to the need for technical support to the technical support system;
receiving a solution to the need for technical support from the technical support system; and
implementing the solution to resolve the need.

42. A method, comprising:
with a printing device, self-determining a need for technical support;
initiating communication with a technical support system without user interaction of the printing device;
providing information corresponding to the need for technical support to the technical support system;
receiving a solution to the need for technical support from the technical support system; and
implementing the solution to resolve the need.

43. A method as recited in claim 42, wherein:
said initiating comprises initiating with the printing device;
said providing comprises providing with the printing device;
said receiving comprises receiving with the printing device; and
said implementing comprises implementing with the printing device.

44. A method as recited in claim 42, further comprising determining the solution by comparing the information with descriptions of device needs for technical support, each description of a device need for technical support corresponding to one or more solutions.

45. A method as recited in claim 42, wherein said implementing comprises displaying user instructions for user interaction with the printing device to said resolve the need.

46. A method as recited in claim 42, wherein said implementing comprises printing user instructions for user interaction with he printing device to said resolve need.

47. A computer-readable medium comprising computer executable instructions that, when executed, direct and printing device to perform a method, comprising:
self-determining a need for technical support;
initiating communication with a technical support system;
providing information corresponding to the need for technical support to the technical support system;
receiving a solution to the need for technical support form the technical support system; and
implementing the solution to resolve the need.
